(19) United States
(12) Patent Application Publication
(10) Pub. No.: US 2024/0286187 A1
(43) Pub. Date: Aug. 29, 2024

(54) CAST HYPEREUTECTIC ALUMINUM ALLOY DISC BRAKE ROTOR

(71) Applicant: Spartan Light Metal Products, Inc., St. Louis, MO (US)

(72) Inventors: Christopher A. Sleath, Ortonville, MI (US); Scott P. Meyer, Waterloo, IL (US); Nigel J. Doerge, Sparta, IL (US); Kevin P. Theophilus, Percy, IL (US); Jimmy D. Doty, Ava, IL (US)

(21) Appl. No.: 18/411,424

(22) Filed: Jan. 12, 2024

Related U.S. Application Data
(60) Provisional application No. 63/448,751, filed on Feb. 28, 2023.

(51) Int. Cl. B22D 17/00; B22D 17/20; B22D 35/00; C22C 21/02; F16D 65/12

(52) U.S. Cl. CPC B22D 17/007; B22D 17/20; B22D 35/00; C22C 21/02; F16D 65/125; F16D 2250/0007

(57) ABSTRACT

A disc brake rotor for a vehicle is provided. The disc brake rotor includes a hat and a friction ring extending circumferentially from the hat. The disc brake rotor is formed of a cast hypereutectic aluminum alloy. The hypereutectic aluminum alloy includes: 14.00 to 25.00 wt. % of silicon; 4.90 to 8.00 wt. % of copper; 0.05 to 0.90 wt. % of nickel; 0.50 to 1.50 wt. % of magnesium; 0.05 to 1.20 wt. % of iron; 0.05 to 1.00 wt. % of manganese; 0.05 to 1.00 wt. % of zinc; 0.05 to 1.20 wt. % of titanium; 0.05 to 1.20 wt. % of zirconium; 0.05 to 1.20 wt. % of vanadium; 0.001 to 0.10 wt. % of phosphorous; and the balance aluminum. The alloy may also include other trace elements such as chromium, lead, and tin in an amount not exceeding 0.20 wt. %. The disc brake rotor may be formed by a high pressure, semi-solid die casting process including rheocasting.

### CROSS REFERENCE TO RELATED APPLICATIONS

This application claims the benefit of U.S. Provisional Application No. 63/448,751, filed Feb. 28, 2023, the disclosure of which is incorporated herein by reference in its entirety.

### FIELD OF THE INVENTION

The disclosure generally relates to brake rotors for vehicles and, more specifically, to a disc brake rotor formed of a cast hypereutectic aluminum alloy.

### BACKGROUND OF THE INVENTION

It is known in the art related to automotive vehicles that reducing the total weight of an automobile can improve its fuel economy to meet increasing fuel efficiency demands. For example, a 10% reduction in vehicle weight may achieve an approximately 6-8% improvement in fuel economy. Therefore, it is desirable to use lighter weight materials for a vehicle's frame, body panels, and component parts. Such materials include high-strength steel, magnesium alloys, aluminum alloys, carbon fiber, and polymer composites. At the same time, it is critical that the choice of lightweight material as a replacement for traditional, heavier weight materials maintains a high level of strength, performance, and durability for the parts formed thereof. In the case of a vehicle disc brake rotor, a brake rotor made from a lightweight material should have high thermal conductivity and diffusivity, as well as good strength and high creep resistance (e.g., resistance to warping over time) at elevated temperatures. However, many lightweight materials including cast aluminum alloys are not capable of operating in applications such as automotive brake rotors, and brake rotors made from these materials may suffer in strength, performance, and durability.

### BRIEF SUMMARY

An improved disc brake rotor is provided. The disc brake rotor includes a hat and a friction ring extending circumferentially from the hat. The disc brake rotor is formed of a cast aluminum alloy. The aluminum alloy comprises: 6.0 to 25.0 wt. % of silicon; 4.9 to 8.0 wt. % of copper; 0.05 to 0.9 wt. % of nickel; 0.5 to 1.5 wt. % of magnesium; 0.05 to 1.2 wt. % of iron; 0.05 to 1.2 wt. % of manganese; 0.05 to 1.0 wt. % of zinc; 0.05 to 1.2 wt. % of titanium; 0.05 to 1.2 wt. % of zirconium; 0.04 to 1.2 wt. % of vanadium; maximum 0.20 wt. % of other trace elements; and the balance aluminum.

In specific embodiments, the other trace elements include one or more of strontium in an amount of 0.001 to 0.10 wt. %, and phosphorus in an amount of 0.001 to 0.10 wt. %.

In specific embodiments, the aluminum alloy is a hypereutectic aluminum alloy comprising: 14.00 to 25.00 wt. % of silicon; 4.90 to 8.00 wt. % of copper; 0.05 to 0.90 wt. % of nickel; 0.50 to 1.50 wt. % of magnesium; 0.05 to 1.20 wt. % of iron; 0.05 to 1.00 wt. % of manganese; 0.05 to 1.00 wt. % of zinc; 0.05 to 1.20 wt. % of titanium; 0.05 to 1.20 wt. % of zirconium; 0.05 to 1.20 wt. % of vanadium; 0.001 to 0.10 wt. % of phosphorous; maximum 0.20 wt. % of other trace elements; and the balance aluminum.

In particular embodiments, the other trace elements of the hypereutectic aluminum alloy include one or more of chromium in an amount of up to 0.10 wt. %, lead in an amount of up to 0.10 wt. %, and tin in an amount of up to 0.10 wt. %.

In certain embodiments, the hypereutectic aluminum alloy has a sludge factor defined as (1×% iron)+(2×% manganese)+(3×% chromium), the sludge factor having a maximum value of 1.8%.

In specific embodiments, the disc brake rotor is formed by a high pressure, semi-solid die casting process.

In particular preferred embodiments, the semi-solid die casting process includes rheocasting, such as preferably an enthalpy exchange process (e.g., a RheoMetal process, more generally an enthalpy exchange material (EEM) process) or alternatively a GISS (gas induced semi-solid) or SEED (swirled enthalpy equilibration device) rheocasting process.

In alternative embodiments, the disc brake rotor may be formed by a high pressure die casting process that includes thixoforming. In yet other alternative embodiments, the disc brake rotor may be formed by a conventional liquid high pressure die casting process.

In specific embodiments, the hat and the friction ring are integrally formed as a monolithic construction.

A method of forming the disc brake rotor is also provided. The method includes forming a liquid-solid metal slurry composition by: charging a vessel with a molten metal or alloy; charging the vessel with a solid metal or alloy; and stirring the molten metal or alloy upon cooling thereof. An amount of solid metal or alloy is chosen such that at least 1 wt. % of solid particles will be formed in the melt due to an enthalpy exchange between the solid metal or alloy and the molten metal or alloy, at least a part of the added solid metal or alloy being melted by heat transferred to the solid metal or alloy by the molten metal or alloy, such that the liquid-solid metal slurry composition is formed. The solid metal or alloy is dissolvable in the molten metal or alloy. The stirring is performed by a mechanical stirrer and the solid metal or alloy is charged to the vessel via the stirrer. The solid metal or alloy is attached directly to the stirrer. However, other methods of introducing solid metal and/or stirring may be used, such as adding solid metal to the ladle before the introduction of molten metal.

In specific embodiments, the liquid-solid metal slurry composition, including formed solid particles, is provided to a casting operation.

In specific embodiments, a mixture of molten metal or alloy and the solid metal or alloy is subjected to a supplementary external cooling besides the cooling effect of the solid metal or alloy.

In specific embodiments, the charged solid metal or alloy has the same composition as the charged molten metal or alloy. However, in other embodiments, the solid metal or alloy may have a different composition as the charged molten metal or alloy, the compositions being set so that the final slurry obtained from combining the solid material and the molten charge material has the desired chemical composition.

In specific embodiments, the liquid-solid metal slurry composition has a spherical or non-dendritic structure.

In specific embodiments, the method further includes: moving the vessel with the produced liquid-solid metal slurry composition to a filling chamber of a high pressure die casting machine; pouring the liquid-solid metal slurry composition into the filling chamber; and casting the disc brake rotor with the liquid-solid metal slurry composition in the high pressure die casting machine.

In particular embodiments, the method further includes subjecting the casted disc brake rotor to an aging treatment.

In particular embodiments, the method further includes subjecting the casted disc brake rotor to a solution heat treatment; quenching the casted disc brake rotor at the end of the solution heat treatment; and subsequently subjecting the disc brake rotor to an aging treatment.

In other embodiments, the method of forming the disc brake rotor includes pouring metal in liquid form into a mold in which an elongated device is introduced. The method further includes keeping the elongated device in the mold until the metal has been casted to the elongated device. The method further includes leading the elongated device with metal casted onto it from the mold into a vessel comprising metal in liquid form. After the elongated device has been led into the vessel comprising the metal in liquid form, the method further includes stirring in the vessel using a stirring device, at least until a majority of the metal casted onto the elongated device has fallen off the elongated device and into the vessel so that a semi-solid metal slurry is produced, the stirring device being rotatable around a rotational axis (X-X), the stirring device including: an elongated shaft extending along the rotational axis (X-X), and at least two wings securely arranged to the elongated shaft and extending radially outwards from the elongated shaft, wherein the at least two wings securely arranged to the elongated shaft and extending radially outwards from the elongated shaft, wherein the at least two wings also have a substantial axial extension along the rotational axis (X-X), the axial extension of the wings at the elongated shaft being at least 15% of a total length of the elongated shaft.

In specific embodiments, the method further includes: moving the vessel with the produced semi-solid metal slurry to a filling chamber of a high pressure die casting machine; pouring the semi-solid metal slurry into the filling chamber; and casting the disc brake rotor with the liquid-solid metal slurry composition in the high pressure die casting machine.

In particular embodiments, the method further includes subjecting the casted disc brake rotor to an aging treatment.

In particular embodiments, the method further includes subjecting the casted disc brake rotor to a solution heat treatment; quenching the casted disc brake rotor at the end of the solution heat treatment; and subsequently subjecting the disc brake rotor to an aging treatment.

### DESCRIPTION OF THE DRAWINGS

Various advantages and aspects of this disclosure may be understood in view of the following detailed description when considered in connection with the accompanying drawings, wherein:

FIG. 1 is a front perspective view of a disc brake rotor in accordance with particular embodiments of the disclosure;

FIG. 2 is a rear perspective view of the disc brake rotor of FIG. 1;

FIG. 3A is a front perspective view of a 4-slide disc brake rotor in accordance with particular embodiments of the disclosure;

FIG. 3B is a front view of the 4-slide disc brake rotor;

FIG. 3C is a side view of the 4-slide disc brake rotor;

FIG. 3D is a rear view of the 4-slide disc brake rotor;

FIG. 3E is a perspective sectional view of the 4-slide disc brake rotor as viewed from the rear;

FIG. 3F is a sectional view of the 4-slide disc brake rotor as viewed from the rear;

FIG. 3G is a sectional view of the 4-slide disc brake rotor as viewed from the front;

FIG. 4A is a front perspective view of a 6-slide disc brake rotor in accordance with particular embodiments of the disclosure;

FIG. 4B is a rear view of the 6-slide disc brake rotor;

FIG. 4C is a side view of the 6-slide disc brake rotor;

FIG. 4D is a front view of the 6-slide disc brake rotor;

FIG. 4E is a rear perspective view of the 6-slide disc brake rotor;

FIG. 4F is a sectional view of the 6-slide disc brake rotor as viewed from the front;

FIG. 4G is a perspective sectional view of the 6-slide disc brake rotor as viewed from the rear;

FIG. 4H is a sectional view of the 4-slide disc brake rotor as viewed from the rear;

FIGS. 5A-D are each portions that together illustrate a process flow diagram of steps of forming a cast hypereutectic aluminum alloy disc brake rotor in accordance with particular embodiments of the disclosure; and

FIG. 6 is a schematic illustration of a process of forming a hypereutectic aluminum alloy semi-solid slurry.

### DETAILED DESCRIPTION OF THE INVENTION

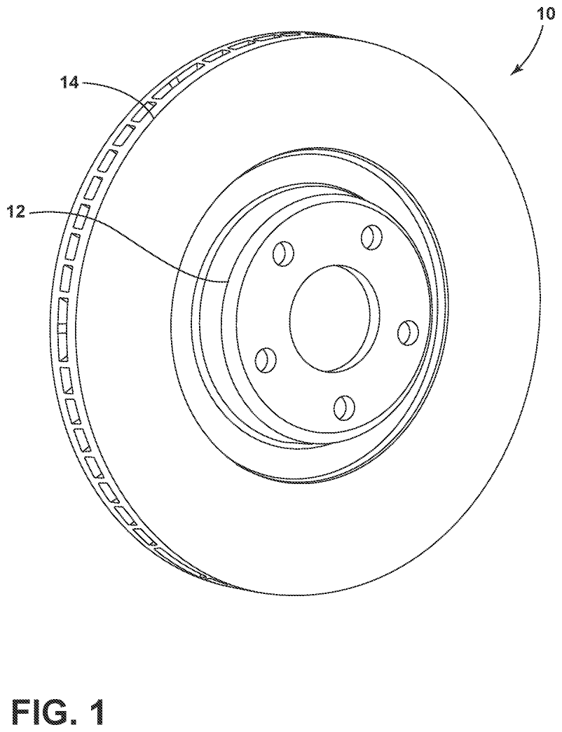

A disc brake rotor is provided. Referring to FIGS. 1 and 2, wherein like numerals indicate corresponding parts throughout the several views, the disc brake rotor is illustrated and generally designated at 10. The disc brake rotor 10 is formed of a cast hypereutectic aluminum alloy by a high pressure, semi-solid die casting process such as a high-pressure rheocasting process or other semi-solid process.

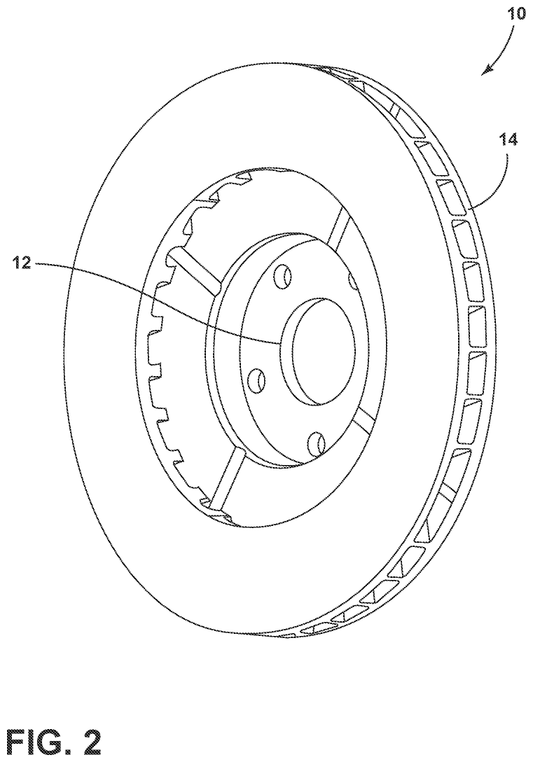

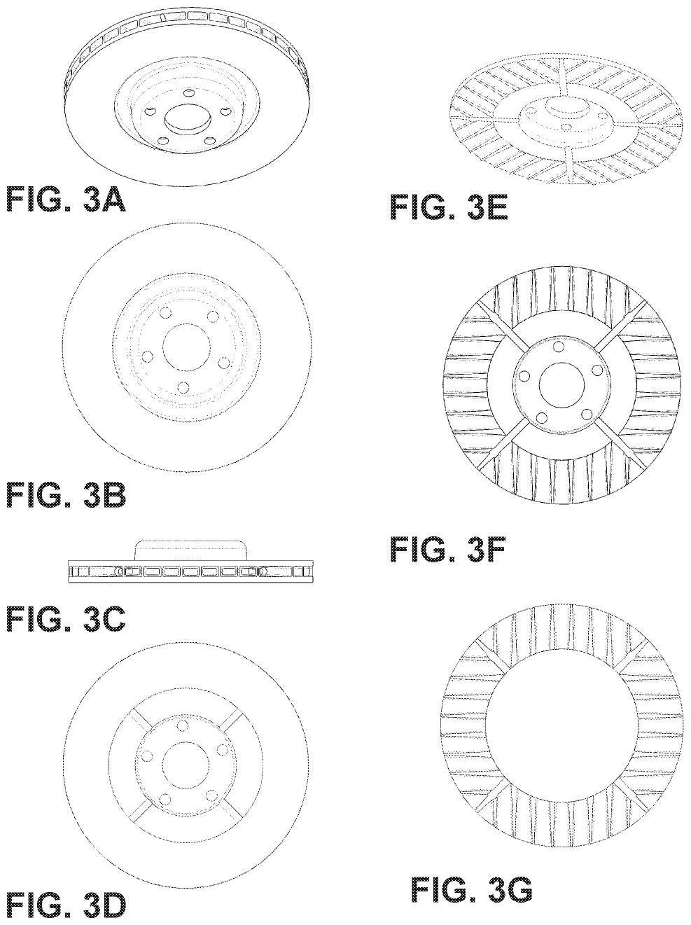

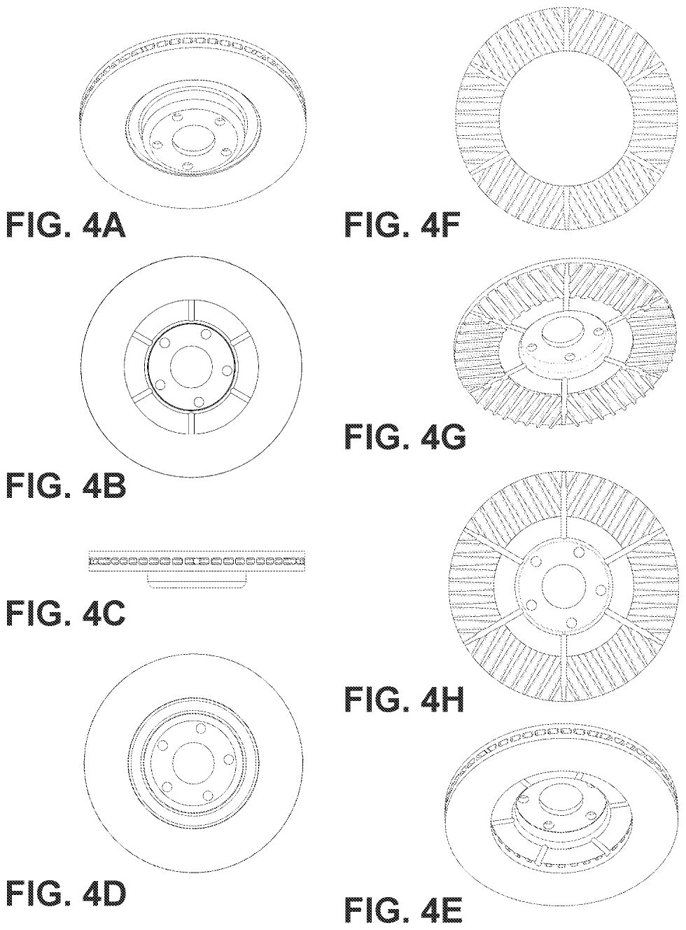

The disc brake rotor 10 is a component of a disc brake system for vehicles including automotive vehicles such as passenger cars, sport utility vehicles, and/or trucks, and which may be, but are not limited to internal combustion engine powered vehicles, battery electric powered vehicles, and hybrid vehicles. Alternatively, the vehicle may be an industrial vehicle, a recreational vehicle, an off-road vehicle, a motorcycle, a semi-trailer, a train, and the like. The disc brake rotor 10 includes a centrally disposed, generally cylindrical bell or hat 12 that is mountable on a wheel hub of a vehicle. A friction plate or ring 14 surrounds the hat and extends circumferentially outward from an outer perimeter of the hat. The friction ring 14 includes a disc-shaped friction surface against which disc pads of the disc brake system engage to affect vehicle braking. Preferably, the disc brake rotor 10 is monolithic in construction such that the hat 12 and friction ring 14 are integrally formed. However, in alternative embodiments, the hat and friction ring are formed separately and later mechanically joined together. Thus, the disc brake rotor may be a solid rotor, a vented rotor, and/or a multipiece rotor. Specific examples of the disc brake rotor are shown in FIGS. 3A-G (4-slide design) and FIGS. 4A-H (6-slide design). These examples are merely for illustrative purposes and are not intended to be limiting. In yet other embodiments, the vents may have other configurations or may be formed by other methods. For example, the disc brake rotor may have other vent configurations (e.g. radial vent slots), the vents of the rotor may be machined, and/or the vents may be made with sand cores.

An exemplary aluminum alloy composition used for casting the disc brake rotor 10 is described in U.S. Pat. No. 6,918,970, the contents of which are hereby incorporated by reference in their entirety. This aluminum alloy is a high-strength Al—Si alloy that is suitable for high temperature applications for cast components such as the present disc brake rotor. This aluminum alloy includes the following elements shown in Table 1, as a percent by weight (wt. %) of the total composition.

TABLE 1
Aluminum Alloy Composition A

| Compositional Element | Wt. % |
|---|---|
| Silicon (Si) | 6.0-25.0 |
| Copper (Cu) | 5.0-8.0 |
| Iron (Fe) | 0.05-1.2 |
| Magnesium (Mg) | 0.5-1.5 |
| Nickel (Ni) | 0.05-0.9 |
| Manganese (Mn) | 0.05-1.2 |
| Titanium (Ti) | 0.05-1.2 |
| Zirconium (Zr) | 0.05-1.2 |
| Vanadium (V) | 0.05-1.2 |
| Zinc (Zn) | 0.05-0.9 |
| Strontium (Sr) | 0.001-0.1 |
| Phosphorus (P) | 0.001-0.1 |
| Aluminum (Al) | Balance |

Silicon gives the alloy a high elastic modulus and low thermal coefficient of expansion. The addition of silicon is essential in order to improve the fluidity of the molten aluminum to enhance the castability of the Al—Si alloy according to the present invention. At high silicon levels, the alloy exhibits excellent surface hardness and wear resistance properties.

Copper co-exists with magnesium and forms a solid solution in the aluminum matrix to give the alloy age-hardening properties, thereby improving the high temperature strength. Copper also forms the θ′ phase compound (Al₂Cu), and is the most potent strengthening element in this alloy. The enhanced high strength at high temperatures is affected if the copper wt % level is not adhered to. Moreover, the alloy strength can only be maximized effectively by the simultaneous formation for both of the θ′ (Al₂Cu) and S′ (Al₂CuMg) metallic compounds, using proper addition of magnesium into the alloy relative to the elements of copper and silicon. Experimentally, it is found that an alloy with a significantly higher level of magnesium will form mostly S′ phase with insufficient amount of θ′ phase. On the other hand, an alloy with a lower level of magnesium contains mostly θ′ phase with insufficient amount of S′ phase.

To maximize the formation of both the θ′ and S′ phases, the alloy composition is specifically formulated with copper-to-magnesium (Cu/Mg) ratios ranging from 4 to 15, with a minimum value for magnesium of no less than 0.5 wt %. In addition to the Cu/Mg ratio, the silicon-to-magnesium (Si/Mg) ratio is kept in the range of 10 to 25, preferably 14 to 20, to properly form the Mg₂Si metallic compound as a minor strengthening phase, in addition to the primary θ′ and S′ phases. Moreover, the unique Cu:Mg ratio greatly enhances the chemical reactions among aluminum (Al), copper (Cu) and magnesium (Mg) atoms. Such chemical reactions permit precipitation of a higher volume fraction of the strengthening phases θ′ and S′ within the alloy. The combination of high volume fraction and coherent θ′ of the composition leads to exceptional tensile strength and microstructure stability at elevated temperatures.

Titanium, vanadium, and zirconium are added to the Al—Si alloy to modify the lattice parameter of the aluminum matrix by forming compounds of the type Al₃X having L1₂ crystal structures (X=Ti, V, Zr). In order to maintain high degrees of strength at temperatures very near to their alloy melting point, both the aluminum solid solution matrix and the particles of Al₃X compounds have similar face-centered-cubic (FCC) crystal structures, and are coherent because their respective lattice parameters and dimensions are closely matched. The compounds of the type Al₃X (X=Ti, V, Zr) particles also act as nuclei for grain size refinement upon the molten aluminum alloy being solidified from the casting process. Titanium and vanadium also function as dispersion strengthening agents, having the L1₂ lattice structure similar to the aluminum solid solution, in order to improve the high temperature mechanical properties. Zirconium also forms a solid solution in the matrix to a small amount, thus enhancing the formation of GP (Guinier-Preston) zones, which are the Cu-Mg rich regions, and the θ′ phase in the Al—Cu-Mg system to improve the age-hardening properties. Although the stable θ′ (Al₂Cu) is the primary strengthening phase at elevated temperatures, the importance of having Ti, V, and Zr elements in the alloy cannot be discounted. Upon the molten alloy being solidified from the casting process, these elements react with aluminum to form Al₃X (X=Ti, V, Zr) compounds that precipitate as nucleation sites for effective grain size refinement. Moreover, Al₃X (X=Ti, V, Zr) precipitates also function as dispersion strengthening agents, effectively blocking the movement of dislocations and enhance the high temperature mechanical properties. High temperature strength characteristics of the alloy are detrimentally affected if Ti, V, and Zr are not used simultaneously in the proper amount for forming Al₃(Ti, V, Zr) precipitates.

Nickel improves the alloy tensile strength at elevated temperatures by reacting with aluminum to form the Al₃Ni₂ and Al₃Ni compounds, which are stable metallurgical phases to resist the degradation effects from the long-term exposure to high temperature environments. Strontium is used to modify the Al—Si eutectic phase. The strength and ductility of Al—Si alloys having less than or equal to 12 wt. % silicon can be substantially improved with finer grains by using strontium as an Al—Si modifier. Addition of strontium is particularly useful for modifying the eutectic structure of hypoeutectic versions of the composition where the silicon content is less than 12 percent by weight, rather than the hypereutectic versions in which the silicon content is greater than 12 percent by weight. Phosphorus, on the other hand, is used to modify the silicon primary particle size when the silicon concentration is greater than 12 wt. % (hypereutectic), preferably 14 to 20. Effective modification is achieved at a very low additional level, but the range of recovered strontium and phosphorus of 0.001 to 0.1 wt. % is commonly used.

In order for these strengthening mechanisms to function properly within the alloy, the casting article such as the disc brake rotor should have a unique combination of chemical composition and heat treatment history. The heat treatment is specifically designed to maximize the performance of the unique chemical composition. The exceptional performance of the alloy is achieved by the combination of the following strengthening mechanisms through a unique heat treatment schedule. The heat treatment for the alloy can maximize the formation of θ′ and S′ phases in the alloy (high volume fraction), stabilize θ′ phase at elevated temperature by controlling Cu/Mg ratio, and maximize the formation of Al₃ (Ti, V, Zr) compounds for additional strengthening with simultaneous addition of Ti, V, and Zr.

Maximum high temperature strength preferably can be attained when using a T5 heat treatment consisting of aging at 400 to 500° F. for a time period of four to twelve hours. The heat treatment schedule complements the unique alloy composition to form a maximum amount of precipitates with uniform distribution and optimum particle size.

In other embodiments, the cast article may be subjected to a full T6 heat treatment. For example, the cast article such as a disc brake rotor cast from the hypereutectic alloy first may be solutionized (subjected to a solution heat treatment) at a temperature of 900 to 1000° F. for a time period of fifteen minutes to four hours. The purpose of the solutionizing step is to dissolve unwanted precipitates and reduce any segregation present in the alloy. After solutionizing, the cast article may be quenched in a quenching medium, at a temperature within the range of 120 to 300° F., most preferably 170 to 250° F. A preferred quenching medium is water, but the quenching medium is not so limited. After quenching, the cast article may be aged (subjected to an aging treatment) at a temperature of 425 to 485° F. for a time period of six to twelve hours.

In some specific embodiments, an aluminum alloy composition suitable for casting the disc brake rotor 10 is a hypereutectic aluminum alloy composition including the following elements shown in Table 2, as a percent by weight (wt. %) of the total composition.

TABLE 2
Aluminum Alloy Composition B

| Compositional Element | Wt. % |
|---|---|
| Silicon (Si) | 14.00-25.00 |
| Copper (Cu) | 4.90-8.00 |
| Iron (Fe) | 0.05-1.20 |
| Nickel (Ni) | 0.05-0.90 |
| Magnesium (Mg) | 0.50-1.50 |
| Manganese (Mn) | 0.05-1.00 |
| Zinc (Zn) | 0.05-1.00 |
| Titanium (Ti) | 0.05-1.20 |
| Zirconium (Zr) | 0.05-1.20 |
| Vanadium (V) | 0.05-1.20 |
| Phosphorous (P) | 0.001-0.10 |
| Other trace elements: | 0.20 max total: |
| Chromium (Cr) | 0.10 max |
| Lead (Pb) | 0.10 max |
| Tin (Sn) | 0.10 max |
| Aluminum (Al) | Balance |

In certain embodiments, the Si content may be in the range of 14.00 to 24.00 wt. %, alternatively in the range of 14.00 to 23.00 wt. %, alternatively in the range of 14.00 to 22.00 wt. %, alternatively in the range of 14.00 to 21.00 wt. %, alternatively in the range of 14.00 to 20.00 wt. %, alternatively in the range of 14.00 to 19.00 wt. %, alternatively in the range of 14.00 to 18.00 wt. %, alternatively in the range of 14.00 to 17.00 wt. %, alternatively in the range of 15.00 to 25.00 wt. %, alternatively in the range of 15.00 to 24.00 wt. %, alternatively in the range of 15.00 to 23.00 wt. %, alternatively in the range of 15.00 to 22.00 wt. %, alternatively in the range of 15.00 to 21.00 wt. %, alternatively in the range of 15.00 to 20.00 wt. %, alternatively in the range of 15.00 to 19.00 wt. %, alternatively in the range of 15.00 to 18.00 wt. %, alternatively in the range of 15.00 to 17.00 wt. %, or alternatively in the range of 15.50 to 16.50 wt. %.

In certain embodiments, the Cu content may be in the range of 4.90 to 7.50 wt. %, alternatively in the range of 4.90 to 7.00 wt. %, alternatively in the range of 4.90 to 6.50 wt. %, alternatively in the range of 4.90 to 6.00 wt. %, alternatively in the range of 4.90 to 5.50 wt. %, alternatively in the range of 5.00 to 8.00 wt. %, alternatively in the range of 5.50 to 8.00 wt. %, alternatively in the range of 6.00 to 8.00 wt. %, alternatively in the range of 6.50 to 8.00 wt. %, alternatively in the range of 7.00 to 8.00 wt. %, or alternatively in the range of 7.50 to 8.00 wt. %.

In certain embodiments, the Fe content may be in the range of 0.05 to 1.15 wt. %, alternatively in the range of 0.05 to 1.10 wt. %, alternatively in the range of 0.05 to 1.05 wt. %, alternatively in the range of 0.05 to 1.00 wt. %, alternatively in the range of 0.10 to 1.20 wt. %, alternatively in the range of 0.15 to 1.20 wt. %, alternatively in the range of 0.20 to 1.20 wt. %, alternatively in the range of 0.25 to 1.20 wt. %, alternatively in the range of 0.30 to 1.20 wt. %, alternatively in the range of 0.35 to 1.20 wt. %, alternatively in the range of 0.40 to 1.20 wt. %, alternatively in the range of 0.45 to 1.20 wt. %, alternatively in the range of 0.50 to 1.20 wt. %, alternatively in the range of 0.55 to 1.20 wt. %, alternatively in the range of 0.60 to 1.20 wt. %, alternatively in the range of 0.65 to 1.20 wt. %, alternatively in the range of 0.70 to 1.20 wt. %, alternatively in the range of 0.75 to 1.20 wt. %, alternatively in the range of 0.80 to 1.20 wt. %, alternatively in the range of 0.85 to 1.20 wt. %, alternatively in the range of 0.90 to 1.20 wt. %, alternatively in the range of 0.90 to 1.15 wt. %, alternatively in the range of 0.90 to 1.10 wt. %, alternatively in the range of 0.90 to 1.05 wt. %, or alternatively in the range of 0.90 to 1.00 wt. %.

In certain embodiments, the Ni content may be in the range of 0.05 to 0.85 wt. %, alternatively in the range of 0.05 to 0.80 wt. %, alternatively in the range of 0.10 to 0.90 wt. %, alternatively in the range of 0.15 to 0.90 wt. %, alternatively in the range of 0.20 to 0.90 wt. %, alternatively in the range of 0.25 to 0.90 wt. %, alternatively in the range of 0.30 to 0.90 wt. %, alternatively in the range of 0.35 to 0.90 wt. %, alternatively in the range of 0.40 to 0.90 wt. %, alternatively in the range of 0.45 to 0.90 wt. %, alternatively in the range of 0.50 to 0.90 wt. %, alternatively in the range of 0.50 to 0.85 wt. %, or alternatively in the range of 0.50 to 0.80 wt. %.

In certain embodiments, the Mg content may be in the range of 0.50 to 1.45 wt. %, alternatively in the range of 0.50 to 1.40 wt. %, alternatively in the range of 0.50 to 1.35 wt. %, alternatively in the range of 0.50 to 1.30 wt. %, alternatively in the range of 0.50 to 1.25 wt. %, alternatively in the range of 0.50 to 1.20 wt. %, alternatively in the range of 0.50 to 1.15 wt. %, alternatively in the range of 0.50 to 1.10 wt. %, alternatively in the range of 0.50 to 1.05 wt. %, alternatively in the range of 0.50 to 1.00 wt. %, alternatively in the range of 0.50 to 0.95 wt. %, alternatively in the range of 0.50 to 0.90 wt. %, alternatively in the range of 0.50 to 0.85 wt. %, alternatively in the range of 0.50 to 0.80 wt. %, alternatively in the range of 0.50 to 0.75 wt. %, alternatively in the range of 0.50 to 0.70 wt. %, or alternatively in the range of 0.50 to 0.65 wt. %.

In certain embodiments, the Mn content may be in the range of 0.10 to 1.00 wt. %, alternatively in the range of 0.15 to 1.00 wt. %, alternatively in the range of 0.20 to 1.00 wt. %, alternatively in the range of 0.05 to 0.95 wt. %, alternatively in the range of 0.05 to 0.90 wt. %, alternatively in the range of 0.05 to 0.85 wt. %, alternatively in the range of 0.05 to 0.80 wt. %, alternatively in the range of 0.05 to 0.75 wt. %, alternatively in the range of 0.05 to 0.70 wt. %, alternatively in the range of 0.05 to 0.65 wt. %, alternatively in the range of 0.05 to 0.60 wt. %, alternatively in the range of 0.05 to 0.55 wt. %, alternatively in the range of 0.05 to 0.50 wt. %, alternatively in the range of 0.05 to 0.45 wt. %, alternatively in the range of 0.05 to 0.40 wt. %, alternatively in the range of 0.05 to 0.35 wt. %, alternatively in the range of 0.10 to 0.35 wt. %, alternatively in the range of 0.15 to 0.35 wt. %, or alternatively in the range of 0.20 to 0.35 wt. %.

In certain embodiments, the Zn content may be in the range of 0.10 to 1.00 wt. %, alternatively in the range of 0.15 to 1.00 wt. %, alternatively in the range of 0.20 to 1.00 wt. %, alternatively in the range of 0.25 to 1.00 wt. %, alternatively in the range of 0.30 to 1.00 wt. %, alternatively in the range of 0.35 to 1.00 wt. %, alternatively in the range of 0.40 to 1.00 wt. %, alternatively in the range of 0.45 to 1.00 wt. %, alternatively in the range of 0.50 to 1.00 wt. %, alternatively in the range of 0.55 to 1.00 wt. %, alternatively in the range of 0.60 to 1.00 wt. %, alternatively in the range of 0.65 to 1.00 wt. %, alternatively in the range of 0.70 to 1.00 wt. %, alternatively in the range of 0.75 to 1.00 wt. %, alternatively in the range of 0.80 to 1.00 wt. %, alternatively in the range of 0.85 to 1.00 wt. %, alternatively in the range of 0.90 to 1.00 wt. %, alternatively in the range of 0.95 to 1.00 wt. %, alternatively in the range of 0.05 to 0.95 wt. %, alternatively in the range of 0.05 to 0.90 wt. %, alternatively in the range of 0.05 to 0.85 wt. %, alternatively in the range of 0.05 to 0.80 wt. %, alternatively in the range of 0.05 to 0.75 wt. %, alternatively in the range of 0.05 to 0.70 wt. %, alternatively in the range of 0.05 to 0.65 wt. %, alternatively in the range of 0.05 to 0.60 wt. %, alternatively in the range of 0.05 to 0.55 wt. %, alternatively in the range of 0.05 to 0.50 wt. %, alternatively in the range of 0.05 to 0.45 wt. %, alternatively in the range of 0.05 to 0.40 wt. %, alternatively in the range of 0.05 to 0.35 wt. %, alternatively in the range of 0.05 to 0.30 wt. %, alternatively in the range of 0.05 to 0.25 wt. %, alternatively in the range of 0.05 to 0.20 wt. %, alternatively in the range of 0.05 to 0.15 wt. %, or alternatively in the range of 0.05 to 0.10 wt. %.

In certain embodiments, the Ti content may be in the range of 0.10 to 1.20 wt. %, alternatively in the range of 0.12 to 1.20 wt. %, alternatively in the range of 0.05 to 1.10 wt. %, alternatively in the range of 0.05 to 1.00 wt. %, alternatively in the range of 0.05 to 0.90 wt. %, alternatively in the range of 0.05 to 0.80 wt. %, alternatively in the range of 0.05 to 0.70 wt. %, alternatively in the range of 0.05 to 0.60 wt. %, alternatively in the range of 0.05 to 0.50 wt. %, alternatively in the range of 0.05 to 0.40 wt. %, alternatively in the range of 0.05 to 0.30 wt. %, alternatively in the range of 0.05 to 0.20 wt. %, alternatively in the range of 0.10 to 0.20 wt. %, or alternatively in the range of 0.12 to 0.20 wt. %.

In certain embodiments, the Zr content may be in the range of 0.10 to 1.20 wt. %, alternatively in the range of 0.15 to 1.20 wt. %, alternatively in the range of 0.20 to 1.20 wt. %, alternatively in the range of 0.05 to 1.10 wt. %, alternatively in the range of 0.05 to 1.00 wt. %, alternatively in the range of 0.05 to 0.90 wt. %, alternatively in the range of 0.05 to 0.80 wt. %, alternatively in the range of 0.05 to 0.70 wt. %, alternatively in the range of 0.05 to 0.60 wt. %, alternatively in the range of 0.05 to 0.50 wt. %, alternatively in the range of 0.05 to 0.40 wt. %, alternatively in the range of 0.05 to 0.30 wt. %, alternatively in the range of 0.10 to 0.30 wt. %, alternatively in the range of 0.15 to 0.30 wt. %, or alternatively in the range of 0.20 to 0.30 wt. %.

In certain embodiments, the V content may be in the range of 0.05 to 1.10 wt. %, alternatively in the range of 0.05 to 1.00 wt. %, alternatively in the range of 0.05 to 0.90 wt. %, alternatively in the range of 0.05 to 0.80 wt. %, alternatively in the range of 0.05 to 0.70 wt. %, alternatively in the range of 0.05 to 0.60 wt. %, alternatively in the range of 0.05 to 0.50 wt. %, alternatively in the range of 0.05 to 0.40 wt. %, alternatively in the range of 0.05 to 0.30 wt. %, alternatively in the range of 0.05 to 0.20 wt. %, or alternatively in the range of 0.05 to 0.10 wt. %.

In certain embodiments, the P content may be in the range of 0.01 to 0.10 wt. %, alternatively in the range of 0.02 to 0.10 wt. %, alternatively in the range of 0.03 to 0.10 wt. %, alternatively in the range of 0.04 to 0.10 wt. %, alternatively in the range of 0.05 to 0.10 wt. %, alternatively in the range of 0.06 to 0.10 wt. %, alternatively in the range of 0.07 to 0.10 wt. %, alternatively in the range of 0.08 to 0.10 wt. %, alternatively in the range of 0.09 to 0.10 wt. %, alternatively in the range of 0.001 to 0.09 wt. %, alternatively in the range of 0.001 to 0.08 wt. %, alternatively in the range of 0.001 to 0.07 wt. %, alternatively in the range of 0.001 to 0.06 wt. %, alternatively in the range of 0.001 to 0.05 wt. %, alternatively in the range of 0.001 to 0.04 wt. %, alternatively in the range of 0.001 to 0.03 wt. %, alternatively in the range of 0.001 to 0.02 wt. %, or alternatively in the range of 0.001 to 0.01 wt. %.

The hypereutectic aluminum alloy composition B further may have a sludge factor having a maximum value of 1.8%, the sludge factor being defined by the following formula: (1×% iron)+(2×% manganese)+(3×% chromium).

In exemplary embodiments, the disc brake rotor 10 is formed by a high pressure, semi-solid die casting process, particularly a high-pressure rheocasting (shear-thinning) process. A preferred rheocasting process is described in U.S. Pat. No. 7,870,885, the contents of which are hereby incorporated by reference in their entirety. Also, a stirring device for producing a semi-solid material slurry and another exemplary rheocasting process is described in U.S. Patent Application Pub. No. 2022/0080499, the contents of which are hereby incorporated by reference in their entirety.

The rheocasting process includes forming a semi-solid slurry. In specific embodiments, the process of forming the semi-solid slurry includes placing an amount of solid metal or alloy such as the herein disclosed hypereutectic aluminum alloy composition in a melting furnace to generate a melt of molten alloy. Subsequently, the melt is poured into a vessel such as a ladle. The wall of the ladle may be formed of or covered with a heat insulating material. The ladle may then be covered with a cover and a mechanical stirrer is inserted through the cover into the ladle and is immersed in the melt. Alternatively, the ladle may not be covered. Further, at least one piece of solid metal or alloy such as a piece of the hypereutectic aluminum alloy is attached to the stirrer. The solid piece of hypereutectic aluminum alloy is dissolvable in the melt, i.e. it will be totally or partially melted by the heat from the melt and will be distributed in the melt. On the other hand, the lower temperature of the solid hypereutectic aluminum alloy will result in an enthalpy exchange with the molten hypereutectic aluminum alloy and in nuclei formation in the melt. The nucleation is supposed to take place on the outer surface or near the outer surface of the solid piece of hypereutectic alloy. However, thanks to the rotation of the stirrer, these new formed nuclei will be thrown out from the surface of the solid piece of hypereutectic aluminum alloy and be distributed relatively uniformly in the melt, thereby forming a generally homogenous slurry. The stirring also increases the heat exchange rate between the charged liquid and solid alloy, thereby making it possible to generate a large amount of slurry in a short time.

The stirrer is then removed from the melt, which is now a liquid-solid metal composition (semi-solid slurry) comprising a molten phase as well as solid particles. The amount of solid particles formed in the melt due to the enthalpy exchange between the charged molten alloy and the charged solid alloy is high enough to substantially prevent the growth of a dendritic structure in the liquid-solid metal composition upon further cooling during any subsequent processing step; such as a casting operation in which the disc brake rotor 10 is formed.

The solid fraction of the slurry can be controlled by adjusting the compositions, the initial temperatures of the charged liquid and metal or alloy and the charged solid metal or alloy as well as the mass ratio between the charged liquid and solid metals or alloys. In many cases, it is desirable to control the solid fraction of the slurry in the range of between 20 to 40%, optionally between 20 to 30%. At this solid fraction, the slurry already has a sufficient amount of solid particles or grains for preventing any dendrite growth, but still has enough fluidity to be poured out of the ladle into a casting device. The slurry can then be poured into a continuous casting device for feedstock production and/or the slurry can then be used for any other type of casting operation such as rheocasting.

In other specific embodiments, the process for producing a semi-solid metal slurry includes providing a system including an oven for melting metal to be used in the process of producing the semi-solid metal slurry. The metal of the semi-solid metal slurry may be any metal or alloy of metals, for example the hypereutectic aluminum alloy composition disclosed herein. The oven may be any kind of oven used for melting metal, i.e. for producing metal in liquid form. The oven may have an open bath in which melted metal is kept, so that it is easy to take up liquid metal from the bath to be used in the system. In order to avoid oxidation, there may be a heavy gas such as nitrogen or helium arranged on the surface of the liquid metal, a gas that will not react with the liquid metal. Further, the bath may be rather deep, i.e. have a delimited volume above the surface so that the heavy gas remains above the metal liquid surface. The oven may further have a thermostat for keeping the melted metal at a rather constant temperature selected for achieving a good result in the slurry-producing process.

The system further includes a first arrangement for handling at least one elongated device onto which metal are to be casted. The first arrangement further has a mold. The system further includes a second arrangement for taking up liquid metal from the oven and pouring it into the mold. The second arrangement may be a robot. The robot may for example have one moveable arm that may be moveable in one joint. The arrangement may have a container, such as a bucket, for taking up the liquid metal from the oven and pouring it into the mold. In order to avoid that the container as such cools the liquid metal, the container may be pre-warmed by holding it in the liquid metal in the oven before it is used for taking up metal from the oven. The second arrangement is further arranged to move the container filled with the liquid metal towards the first arrangement and to pour the liquid metal into the mold. When the liquid metal is poured into the mold, a first of the at least one elongated devices is already inserted into the mold. Alternatively, the first elongated device may be inserted into the mold after the liquid metal has been poured into the mold. The size of the mold is adapted so that when the elongated device is inserted and metal is poured over the mold, a defined amount of metal will be in the mold, comprising the amount of solid metal that is desired to be inserted into the slurry.

The first arrangement may have a plurality of different units, such as four units, each unit holding one elongated device. The elongated devices are rotated stepwise by the first arrangement around a rotational axis X so that one elongated device at a step is inserted into the mold and poured over with liquid metal. After the first elongated device has been inserted into the mold and liquid metal has been poured into the mold by the second arrangement, the first elongated device is kept in the mold a defined time until the liquid metal has solidified. After the defined time has elapsed, the elongated devices are rotated one more step so that the first elongated device is taken out of the mold and a second elongated device is inserted into the mold, where after liquid metal from the oven is poured into the mold, etc.

When the first elongated device has been rotated a step after it was in the mold, the first arrangement controls that there is a correct amount of solid metal casted onto the first elongated device. Thereafter, one or more steps in the rotation process are used for cooling the solid metal casted onto the device to a correct temperature for producing a semi-solid metal slurry. After the first device has been rotated some steps by the first arrangement, the first device should have a suitable amount of solid metal casted onto it, the solid metal having a suitable temperature for producing a semi-solid metal slurry.

While metal is casted onto an elongated device, a third arrangement fills an open vessel (for example, which may be in the form of a ladle) with a predefined amount of liquid metal from the oven and moves the open vessel towards the first arrangement. The third arrangement may be a robot. As the first elongated device has been rotated a couple of steps and reached a predefined position and is ready for being used in the producing of the slurry, the third arrangement moves the open vessel towards the predefined position. More precisely, the open vessel is moved so that the first elongated device is put down into the liquid metal in the open vessel. The first elongated device is then kept in the vessel until the metal casted onto the first elongated device has fallen into the vessel and a semi-solid metal slurry has been created. During the process of keeping the first elongated device in the vessel, a stirring device is rotated in the vessel in order to stir the mixture of solid and liquid metal. The stirring in the vessel is performed at least until a majority of the metal casted onto the first elongated device has fallen off the first elongated device and into the vessel so that a semi-solid metal slurry is produced.

Then the vessel with the produced semi-solid metal slurry is moved by the third arrangement to a filling chamber of a casting machine such as a high-pressure rheocasting machine, and the semi-solid metal slurry is poured into the filing chamber. In certain embodiments, the stirring is performed right until the slurry is poured into the filling chamber.

As the production is performed in steps, when the metal casted onto the first elongated device has fallen off the first elongated device, the first elongated device continues its rotational movement stepwise. The first elongated device may now be cleaned from possible additional solid metal before it is ready to be used in the mold again, and undergo the same procedure again with casting in the mold, cooling, putting down into the vessel with liquid metal and back to the molding after the casted metal has fallen off the first elongated device and into the vessel. During the described process of the first elongated device, the second elongated device undergoes the same procedure, just one step after the first elongated device, and subsequent elongated devices follows one or more steps later than the second elongated device. Alternatively, the process may include only one elongated device.

In some embodiments, the elongated device(s) are also used as stirring device(s). According to other embodiments, the stirring device is a device separate from the elongated device(s), such as a device controlled by the third arrangement. In these embodiments, the stirring device is put down into the open vessel during the production of the slurry, i.e. the stirring device is then at least partly in the slurry at the same time as the respective elongated device is there.

The stirring device includes an elongated shaft having a first end and a second end distal to the first end. The first end is arranged for insertion into a rotation-providing machine, such as the third arrangement. The elongated shaft extends along an axis X-X, which also functions as a rotational axis when the stirring device is rotated by the third arrangement. The elongated shaft has a circular cross section with a diameter D. However, other cross-sectional forms may apply, such as a quadratic cross-section. The elongated shaft has a length L along the axis X-X.

The stirring device further includes wings, preferably arranged at the second end of the shaft. The wings extend radially outwards from the elongated shaft. “Extending radially outwards” signifies extending in a radial direction compared to the rotational axis X-X. i.e. extending perpendicular to the rotational axis X-X. In some embodiments, there are two wings that extend in opposite directions. However, in other embodiments there may be more than two wings, such as three or four wings or even more wings. The wings are then preferably spread out evenly around the elongated shaft. The wings also have a substantial extension along the elongated shaft, also called axial extension. For example, the wings have an axial extension that is at least 10% of the total length L of the shaft, more preferably at least 15%, more preferably at least 20%, and most preferably at least 25%. According to another example, the wings have an axial extension of at least 20 mm. According to another example, the wings have an axial extension that is adapted to a depth which the stirring device is to be inserted into the liquid metal in the vessel. The axial extension of the wings may be 30-70% of the depth that the stirring device is to be inserted into the liquid metal. This means that when the wings extend to the distal end of the shaft, the wings end so that about 30-70% of the elongated shaft that is below a surface of the liquid metal is not equipped with wings. Hereby, a suitable shearing force is achieved on the slurry.

According to some embodiments, the wings are tapered axially in a direction radially outwardly from the shaft. In other words, the wings each have a first axial extension B₁ at the shaft and a second axial extension B₂ at its end distal from the shaft, wherein B₂<B₁. According to an embodiment, the first axial extension B₁ is at least 15% of the total length, more preferably at least 25%, more preferably at least 35% and most preferably at least 40% of the total length L of the shaft. According to another embodiment, the second axial extension B₂ is 5-30% less of the total length L than the first axial extension B₁, and the second axial extension B₂ is 25-45% shorter than the first axial extension B₁. The wings further have a radial extension A and a thickness C in the angular direction, i.e. perpendicular to the radial direction. The thickness C may be less than half the radial extension A. The thickness C of each wing may be the same along the radial extension, i.e. the thickness is the same at its end secured to the shaft as at its end distal to the shaft. The thickness C may be smaller than the diameter D of the elongated shaft. For example, the thickness C may be 50-80% of the diameter D. The measures of A, B₁, B₂, C, D and L may be varied depending on the size of the slurries that are to be produced.

The stirring device as well as the elongated devices are made of a material that has a higher melting point than the melting point of the metal in the slurry. Further, the material of the elongated devices as well as the stirring device is made of a material that does not react with the metal in the slurry. The material may be, for example, stainless acid-resisting steel or a ceramic material or the stirring device may be coated with a ceramic material.

The at least two wings each may have a substantially same thickness along their radial extension. Also, the thickness of each of the at least two wings may be smaller than a thickness of the elongated shaft.

The formation of the slurry as described above is typically applied to hypoeutectic alloys rather than the hypereutectic alloys as disclosed herein (Table 2-hypereutectic aluminum alloy composition B). In using the semi-solid slurry production method described above with hypereutectic aluminum alloys as described herein, a key factor is to monitor the formation of crystals during cooling so that the crystals are not formed uncontrollably.

Once the semi-solid metal slurry is formed, for example by one of the methods described above, the semi-solid metal slurry is moved to and/or poured directly into a filling (introduction) chamber of a high-pressure die machine. The high-pressure die machine may be any conventional die-cast machine, and any size machine is acceptable. In the high-pressure die machine, the semi-solid metal slurry of the hypereutectic aluminum alloy composition is injected under high pressure into the die to form the disc brake rotor 10. In conventional high-pressure die processes, a significant amount of liquid and air may be introduced into the die, which can lead to undesired pores in the finished cast product. On the other hand, when utilizing rheocasting (forming the semi-solid metal slurry as described above) in combination with high-pressure die processes, there is no introduction of air into the die so no porosity is found in the finished metal of the cast product. In addition, rheocasting leads to the formation of globular microstructures that solidify out to increase the thermal conductivity and diffusivity of the finished cast product. For example, in the case of a disc brake rotor, this increases the ability of the rotor to draw heat away during use. Also, since the semi-solid metal slurry is injected at high pressure and high speed, residual stress is not built into the metal of the finished cast product. For example, in the case of a disc brake rotor, the rotor resists warping when heated and cooled during use. Moreover, rheocasting allows for the formation of thinner and thicker wall thicknesses in the finished cast product in comparison to traditional die cast processes. For example, in traditional die cast processes it is difficult to inject a metal into small crevices of a die, whereas when injecting a semi-solid metal slurry under high pressure, injection into such crevices is possible, allowing for the formation of more complex geometries. Further, while small crevices may be filled with traditional high-pressure die cast processes, it is difficult in these processes to completely fill extremely tall, long ribs such as large heat exchanger fins as the metal begins to solidify (dendritic microstructure) in the die. In contrast, the shear-thinning behavior of rheocasting aides in the full, complete filling of this type of structure because the globular slurry remains flowable for a much longer time and at much higher solid fractions. Also, in traditional die cast processes it is not possible to form large wall thicknesses without getting porosity in the finished cast product, whereas high pressure rheocasting allows for the formation of wall thicknesses larger than traditional processes without the adverse formation of pores.

Thus, rheocasting is desirable for the formation of disc brake rotors for a few reasons. For one, the shear-thinning behavior of the slurry helps fill the die cavity while minimizing entrapped gas, thereby reducing gas porosity defects in the cast rotor. Second, the partially solidified slurry shrinks less during solidification in comparison to a fully liquid metal, thereby reducing shrink porosity in thick sections of the cast rotor. These factors allow for the use of a larger die in a smaller high-pressure machine. Third, the slurry temperature when poured into the shot sleeve of the high-pressure die machine is lower than traditional liquid metal temperatures (i.e., virtually no superheat), which leads to lower thermal swings in the die and improved die life, such as potentially a two to four-fold increase in die life in comparison to traditional high-pressure die casting.

After formation of the high-pressure die rheocasted disc brake rotor 10, the disc brake rotor may be subjected to a T5 aging process and/or a full solution T6 heat treatment such as described above. For example, the casted disc brake rotor may be subjected to a full solution heat treatment, then quenched, followed by an aging treatment. In contrast to products formed by traditional processes, a high pressure rheocasted product can be subjected to heat treatments because there are no air bubbles or pores formed in the cast product. These bubbles, when present, undesirably rise to the surface and blister when heated.

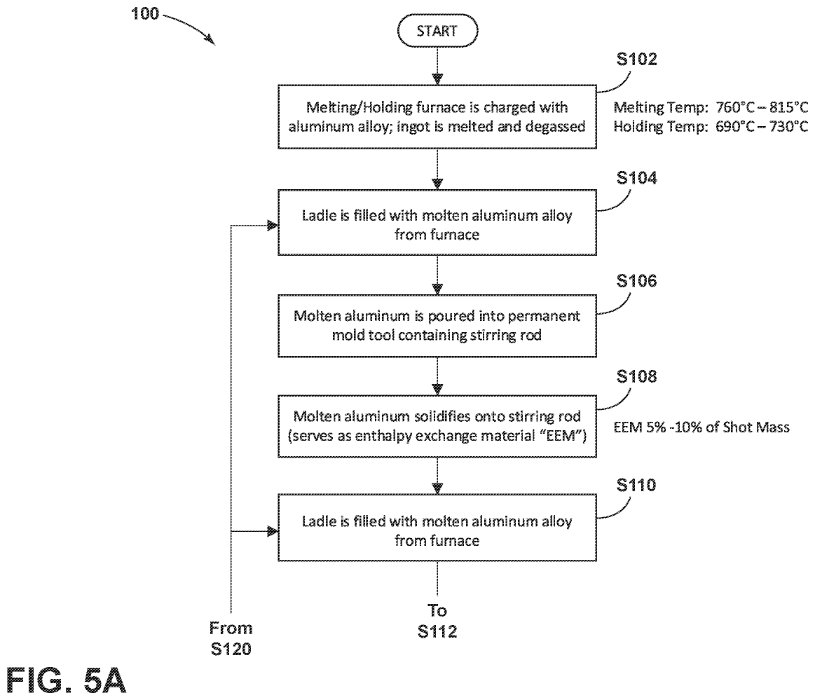

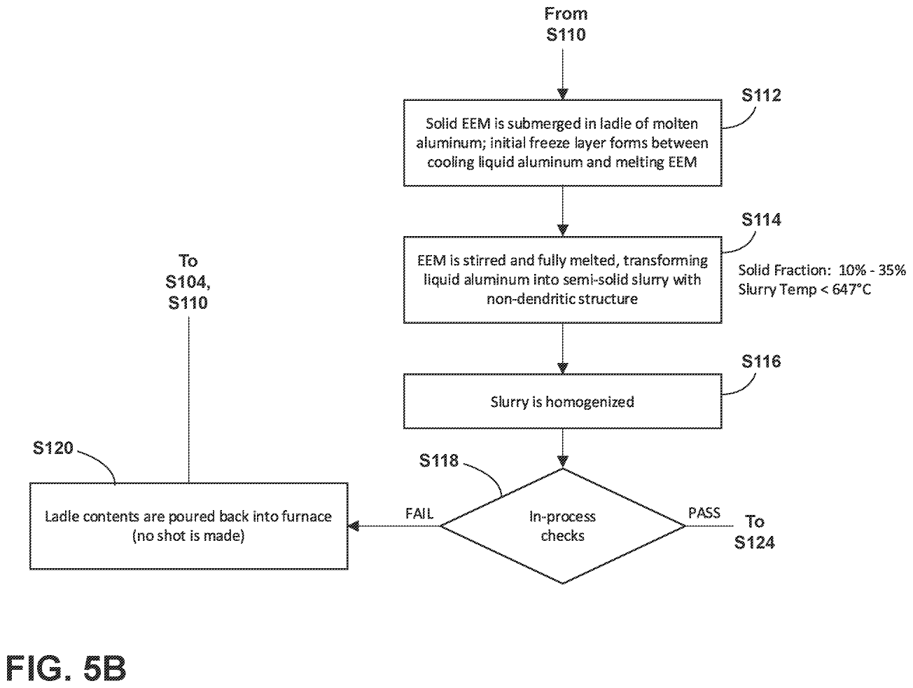

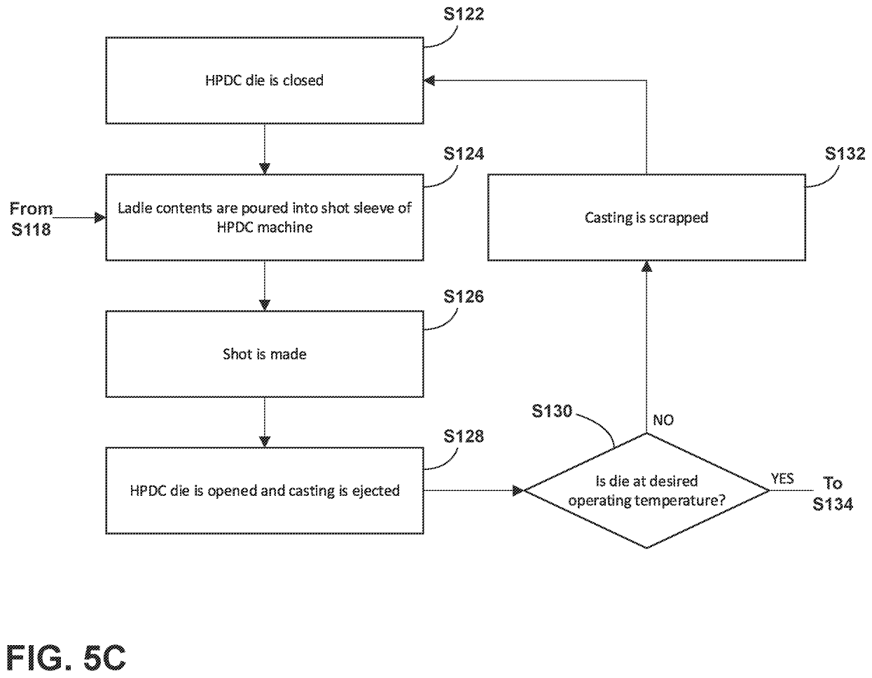

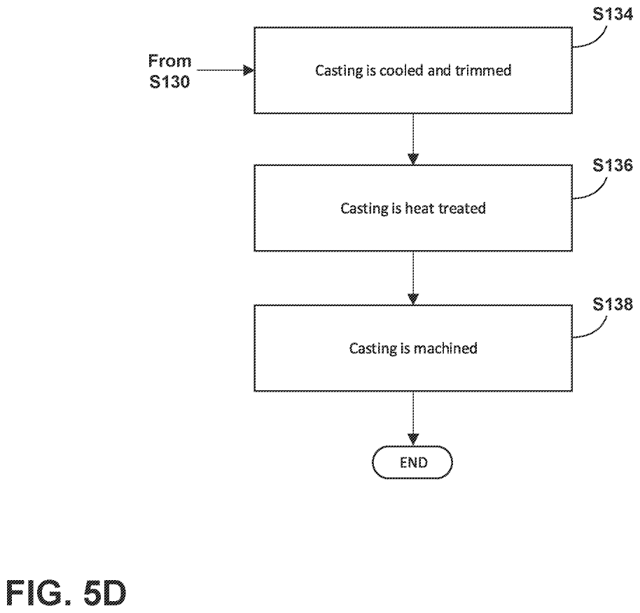

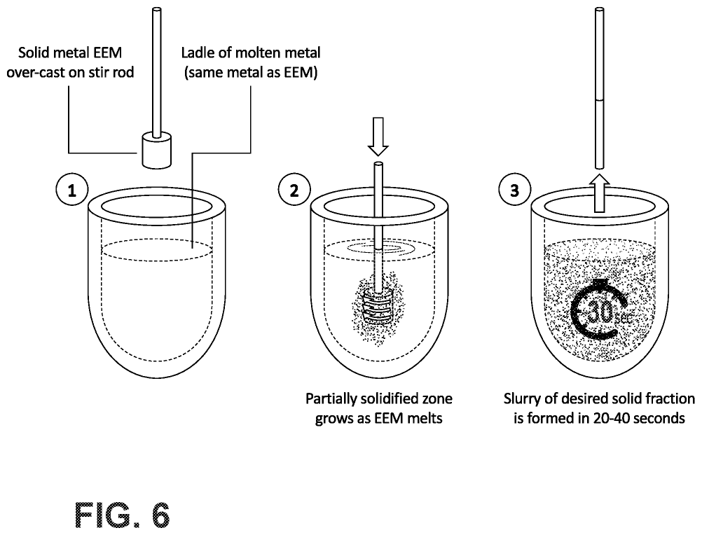

Turning now to FIGS. 5A-D, a flowchart of a method 100 of forming the disc brake rotor 10 is illustrated. The process begins with the melting/holding furnace being charged with an aluminum alloy at step S102. The melt temperature (for silicon into solution) is in a range of approximately 760° C. to 815° C., optionally around 790° C.±10° C. The furnace hold temperature is in a range of approximately 690° C. to 730° C., optionally around 710° C.±10° C. The ingot is melted and degassed, resulting in a liquid with approximately 50° C. to 60° C. of superheat. Next, the ladle is filed with molten aluminum alloy from the furnace at step S104, and the molten aluminum alloy is poured into a permanent mold tool containing a stirring rod at step S106. The molten aluminum alloy is thus over-cast onto the stirring rod, thereby solidifying onto the stirring rod to serve as the enthalpy exchange material (“EEM”) at step S108. The EEM will later constitute around 5% to 10% (e.g., 6.5%) of the shot mass. The solid EEM is cooled to a range of approximately 30° C. to 80° C., preferably as cool as possible. The ladle is again filed with molten aluminum alloy from the furnace at step S110, with the ladle temperature being about the same as the furnace hold temperature, i.e. in the range of approximately 690° C. to 730° C. The solid, cool EEM is submerged and immersed in the ladle of molten aluminum alloy at step S112, and rotated at a high rpm such as in the neighborhood of 300 rpm. An initial freeze layer (partially solidified zone) forms between the cooling liquid aluminum alloy and the melting EEM. The EEM is stirred and fully melted at step S114, transforming the liquid aluminum alloy into a semi-solid, viscous slurry with globular (non-dendritic) grains after approximately 30 seconds of stirring. The shearing causes the crystals to become globular (rounded) rather than dendritic (tree-like) as typically occurs in conventional casting. The globular microstructure is critical to the flowability of the obtained slurry. The temperature of the obtained slurry may be less than 647° C. with a solid fraction in a range of 10% to 35%. The process of forming the semi-solid slurry is shown schematically in FIG. 6 (generally corresponding to steps S110 through S114), wherein the semi-solid slurry of the desired solid fraction is created in approximately 30 seconds, such as in the range of 20 to 40 seconds. The semi-solid slurry is homogenized at step S116, and in-process checks are performed at step S118 to check the quality of the semi-solid slurry before proceeding. If the semi-solid slurry does not pass the checks, the ladle contents are poured back into the furnace (i.e., no shot is made) at step 120, and the method returns to either forming the EEM or filing the ladle with molten aluminum alloy into which the EEM is submerged.

If the semi-solid slurry passes the in-process checks at step S118, the method proceeds to die casting. Specifically, the die of high-pressure die casting (“HPDC”) machine is closed at step S122 and the contents of the ladle (semi-solid slurry) are poured into the shot sleeve of the HPDC machine at step S124. The slurry can remain in the semi-solid, pourable state for approximately 90 seconds after its formation. A shot is made at step S126, and the HPDC die is opened to eject the casting (i.e., the disc brake rotor) at step S128. If the die is not at the desired operating temperature (i.e., if the die is still in its warm-up phase) at step S130, the casting is scrapped at step S132 and the process returns to the steps of closing the die and pouring a new semi-solid slurry (obtained from another set of steps S104 through S118) into the shot sleeve at steps S122 and S124. If, on the other hand, the die is at operating temperature at step S130, the casting is cooled and trimmed at step S134. Subsequently, the casting is subjected to a heat treatment (e.g., a T5 treatment but alternatively a T6 treatment) at step S136, and then the casting is machined to obtain the final product at final step S138 which ends the process.

In other embodiments, as an alternative to high-pressure die casting, other casting methods may be used, including but not limited to low pressure, sand, gravity, and investment casting methods.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A disc brake rotor for a vehicle, the disc brake rotor comprising:
a hat; and
a friction ring extending circumferentially from the hat;
wherein the disc brake rotor is formed of a cast aluminum alloy, the aluminum alloy comprising:
6.0 to 25.0 wt. % of silicon;
4.9 to 8.0 wt. % of copper;
0.05 to 0.9 wt. % of nickel;
0.5 to 1.5 wt. % of magnesium;
0.05 to 1.2 wt. % of iron;
0.05 to 1.2 wt. % of manganese;
0.05 to 1.0 wt. % of zinc;
0.05 to 1.2 wt. % of titanium;
0.05 to 1.2 wt. % of zirconium;
0.04 to 1.2 wt. % of vanadium;
maximum 0.20 wt. % of other trace elements; and
the balance aluminum.

2. The disc brake rotor of claim 1, wherein the other trace elements include one or more of strontium in an amount of 0.001 to 0.10 wt. %, and phosphorus in an amount of 0.001 to 0.10 wt. %.

3. The disc brake rotor of claim 1, wherein the aluminum alloy is a hypereutectic aluminum alloy comprising:
14.00 to 25.00 wt. % of silicon;
4.90 to 8.00 wt. % of copper;
0.05 to 0.90 wt. % of nickel;
0.50 to 1.50 wt. % of magnesium;
0.05 to 1.20 wt. % of iron;
0.05 to 1.00 wt. % of manganese;
0.05 to 1.00 wt. % of zinc;
0.05 to 1.20 wt. % of titanium;
0.05 to 1.20 wt. % of zirconium;
0.05 to 1.20 wt. % of vanadium;
0.001 to 0.10 wt. % of phosphorous;
maximum 0.20 wt. % of other trace elements; and
the balance aluminum.

4. The disc brake rotor of claim 3, wherein the other trace elements include one or more of chromium in an amount of up to 0.10 wt. %, lead in an amount of up to 0.10 wt. %, and tin in an amount of up to 0.10 wt. %.

5. The disc brake rotor of claim 4, wherein the hypereutectic aluminum alloy has a sludge factor defined as (1×% iron)+(2×% manganese)+(3×% chromium), the sludge factor having a maximum value of 1.8%.

6. The disc brake rotor of claim 1, wherein the disc brake rotor is formed by a high pressure, semi-solid die casting process.

7. The disc brake rotor of claim 6, wherein the semi-solid die casting process includes rheocasting.

8. The disc brake rotor of claim 1, wherein the hat and the friction ring are integrally formed as a monolithic construction.

9. A method of forming the disc brake rotor of claim 1, the method comprising:
forming a liquid-solid metal slurry composition by:
charging a vessel with a molten metal or alloy;
charging the vessel with a solid metal or alloy; and
stirring the molten metal or alloy upon cooling thereof;
wherein an amount of solid metal or alloy is chosen such that at least 1 wt. % of solid particles will be formed in the melt due to an enthalpy exchange between the solid metal or alloy and the molten metal or alloy, at least a part of the added solid metal or alloy being melted by heat transferred to the solid metal or alloy by the molten metal or alloy, such that the liquid-solid metal slurry composition is formed;
the solid metal or alloy is dissolvable in the molten metal or alloy;
the stirring is performed by a mechanical stirrer and the solid metal or alloy is charged to the vessel via the stirrer; and
the solid metal or alloy is attached directly to the stirrer.

10. The method of claim 9, wherein the liquid-solid metal slurry composition, including formed solid particles, is provided to a casting operation.

11. The method of claim 9, wherein a mixture of molten metal or alloy and the solid metal or alloy is subjected to a supplementary external cooling besides the cooling effect of the solid metal or alloy.

12. The method of claim 9, wherein the charged solid metal or alloy has the same composition as the charged molten metal or alloy.

13. The method of claim 9, wherein the liquid-solid metal slurry composition has a spherical or non-dendritic structure.

14. The method of claim 9, further including the steps of:
moving the vessel with the produced liquid-solid metal slurry composition to a filling chamber of a high pressure die casting machine;
pouring the liquid-solid metal slurry composition into the filling chamber; and
casting the disc brake rotor with the liquid-solid metal slurry composition in the high pressure die casting machine.

15. The method of claim 14, further including the step of:
subjecting the casted disc brake rotor to an aging treatment.

16. The method of claim 14, further including the steps of:
subjecting the casted disc brake rotor to a solution heat treatment;
quenching the casted disc brake rotor at the end of the solution heat treatment; and
subsequently subjecting the disc brake rotor to an aging treatment.

17. A method of forming the disc brake rotor of claim 1, the method comprising:
pouring metal in liquid form into a mold in which an elongated device is introduced;
keeping the elongated device in the mold until the metal has been casted to the elongated device;
leading the elongated device with metal casted onto it from the mold into a vessel comprising metal in liquid form; and
after the elongated device has been led into the vessel comprising the metal in liquid form, stirring in the vessel using a stirring device, at least until a majority of the metal casted onto the elongated device has fallen off the elongated device and into the vessel so that a semi-solid metal slurry is produced, the stirring device being rotatable around a rotational axis (X-X), the stirring device including: an elongated shaft extending along the rotational axis (X-X), and at least two wings securely arranged to the elongated shaft and extending radially outwards from the elongated shaft, wherein the at least two wings securely arranged to the elongated shaft and extending radially outwards from the elongated shaft, wherein the at least two wings also have a substantial axial extension along the rotational axis (X-X), the axial extension of the wings at the elongated shaft being at least 15% of a total length of the elongated shaft.

18. The method of claim 17, further including the steps of:
moving the vessel with the produced semi-solid metal slurry to a filling chamber of a high pressure die casting machine;
pouring the semi-solid metal slurry into the filling chamber; and
casting the disc brake rotor with the liquid-solid metal slurry composition in the high pressure die casting machine.

19. The method of claim 18, further including the step of:
subjecting the casted disc brake rotor to an aging treatment.

20. The method of claim 18, further including the steps of:
subjecting the casted disc brake rotor to a solution heat treatment;
quenching the casted disc brake rotor at the end of the solution heat treatment; and
subsequently subjecting the disc brake rotor to an aging treatment.

21. A method of forming a disc brake rotor, the method comprising the steps of:
providing a hypereutectic aluminum alloy, wherein the hypereutectic aluminum alloy includes:
14.00 to 25.00 wt. % of silicon;
4.90 to 8.00 wt. % of copper;
0.05 to 0.90 wt. % of nickel;
0.50 to 1.50 wt. % of magnesium;
0.05 to 1.20 wt. % of iron;
0.05 to 1.00 wt. % of manganese;
0.05 to 1.00 wt. % of zinc;
0.05 to 1.20 wt. % of titanium;
0.05 to 1.20 wt. % of zirconium;
0.05 to 1.20 wt. % of vanadium;
0.001 to 0.10 wt. % of phosphorous;
maximum 0.20 wt. % of other trace elements; and
the balance aluminum;
forming a semi-solid slurry of the hypereutectic aluminum alloy;
introducing the semi-solid slurry to the die of a high-pressure die casting machine, wherein the disc brake rotor is cast in the die;
cooling and trimming the cast disc brake rotor; and
subjecting the cast disc brake rotor to a heat treatment.

22. A disc brake rotor formed by the method of claim 21.
